(19) United States
(12) Patent Application Publication
(10) Pub. No.: US 2026/0017120 A1
(43) Pub. Date: Jan. 15, 2026

(54) SYSTEM AND METHOD FOR CONSOLIDATING WORKLOADS IN DATA CENTER

(71) Applicant: Centre for Intelligent Multidimensional Data Analysis Limited, Pak Shek Kok (HK)

(72) Inventors: Chao Guo, Pak Shek Kok (HK); Moshe Zukerman, Pak Shek Kok (HK)

(21) Appl. No.: 18/767,244

(22) Filed: Jul. 9, 2024

(51) Int. Cl. G06F 9/50

(52) U.S. Cl. CPC G06F 9/5083; G06F 9/5094

(57) ABSTRACT

A computer-implemented method for consolidating workloads in a data center. The method includes obtaining information associated with workloads in the data center and optimizing an objective function for workload consolidation based at least in part on the obtained information. The objective function is established for optimizing energy efficiency and workload migration in the data center. The method further includes obtaining, based at least in part on optimizing the objective function, a plurality of Pareto optimal solutions. Each Pareto optimal solution respectively represents an optimal energy efficiency for a corresponding number of migrations associated with the workloads or an optimal number of migrations associated with the workloads for a corresponding energy efficiency. The method further includes consolidating the workloads in the data center based at least in part on at least one of the plurality of Pareto optimal solutions.

### TECHNICAL FIELD

This invention relates to workload consolidation in data center.

### BACKGROUND

Data centers are used to provide information technology (IT) resources for IT operations. Traditional data centers with server-based architecture include computing resources (such as central processing unit (CPU), memory, and accelerators) isolated within individual servers. Such architecture may suffer from the problem of resource stranding. For example, in the server-based architecture, memory stranding may arise when a CPU resource in a server is fully utilized while the memory resource in the same server remains under-utilized (i.e., at least partly non-utilized), and the non-utilized part of the memory resource cannot be used by the CPUs in other servers. This may lead to inefficient resource utilization. The server-based architecture may also suffer from the problem of insufficient memory channel bandwidth per CPU core. To address this problem, an effective memory scalability solution is required to enhance overall computing performance.

To address some of the problems with traditional data centers with server-based architecture, data centers with composable or disaggregated infrastructure have been developed. The composable or disaggregated infrastructure utilizes high-speed interconnection, e.g., optical networking and Compute Express Link (CXL), to interconnect different computing resources to form shared resource pools. The composable or disaggregated infrastructure can address the memory stranding problem, e.g., by reassigning the non-utilized part of the memory resource to other CPUs. Also, in the composable or disaggregated infrastructure, a CPU can be assigned with memory from the shared memory pool. This helps to relieve the memory scalability challenge associated with the server-based architecture.

Regardless of the type of architecture of the data center, one important aspect in operation of data center relates to resource allocation, in particular workload consolidation, which aims to improve resource efficiency by rearranging workloads distributed across a larger number of hardware nodes onto a smaller number of hardware nodes. Unlike other resource allocation operations that require consideration of workload arrivals and departures, workload consolidation is arranged to consolidate workloads that are already being served by the data center. In some cases, workload consolidation may also be referred to as Virtual Machine (VM) consolidation, in particular when workloads are hosted within VMs and the migration of a workload from one host to another involves VM migration technique. Existing VM migration techniques include, e.g., pre-copy live VM migration technique. While these techniques are generally robust, in operation, data must be copied from the source host to the new host in the migration process and this leads to network overheads. Additionally, the workload migration process may incur non-negligible or significant downtime, which can lead to service interruptions. Thus, there exists a trade-off between the efficiency gains (achieved through workload consolidation) and the associated migration cost (e.g., due to network overheads and service interruption).

### SUMMARY

In a first aspect, there is provided a computer-implemented method for consolidating workloads (computational tasks) in a data center. The computer-implemented method comprises obtaining information associated with workloads, preferably existing workloads being processed, in the data center, and optimizing an objective function for workload consolidation based at least in part on the obtained information. The objective function is established for optimizing energy efficiency and workload migration in the data center. The computer-implemented method further comprises obtaining, based at least in part on optimizing the objective function, a plurality of Pareto optimal solutions. Each Pareto optimal solution respectively represents an optimal energy efficiency for a corresponding number of migrations associated with the workloads or an optimal number of migrations associated with the workloads for a corresponding energy efficiency. The computer-implemented method further comprises consolidating the workloads in the data center based at least in part on at least one of the plurality of Pareto optimal solutions.

The computer-implemented method can facilitate optimal workload consolidation in the data center.

In some embodiments, the objective function is established to optimize the energy efficiency and the workload migration by maximizing the energy efficiency and minimizing the number of migrations associated with the workloads.

In some embodiments, the data center comprises a plurality of nodes each respectively comprising one or more types of computing resource. In some embodiments, the plurality of nodes comprises active nodes and optionally inactive nodes. The workloads are distributed in the active nodes. In some embodiments, the objective function is established to optimize the energy efficiency and the workload migration by minimizing the number of active nodes in the data center and minimizing the number of migrations associated with the workloads.

In some embodiments, the objective function is representable as:

$$θ \cdot {N}^{A c t} + ( 1 - θ ) \cdot {N}^{M i g}$$

where N^{Act} is the number of active nodes, N^{Mig} is the number of migrations associated with the workloads, and θ∈[0, 1] is a weight factor.

In some embodiments, optimizing the objective function comprises applying different weight factors (i.e., different values of the weight factor θ) to the objective function to minimize the objective function.

In some embodiments, the number of migrations associated with the workloads is the number of migrations of the workloads. In some embodiments, consolidating the workloads comprises migrating one or some of the workloads from one or more of the active nodes to another one or more of the active nodes to reduce the number of active nodes. Preferably, the migration is in accordance with the type of computing resource required/used by the workload (i.e., the migration is between same type of active nodes).

In some embodiments, the data center has a server-based architecture, in which each of the plurality of nodes is respectively associated with a server having a plurality of types of computing resources. The types of computing resources may include: processing resource (e.g., CPU, GPU, FPGA, etc.), memory resource (includes volatile and/or non-volatile memory), storage resource (e.g., SSD), and/or communication resource (e.g., NIC). In some embodiments, the plurality of nodes comprises a plurality of processing nodes each comprising processing resource (and optionally memory resource), and the active nodes comprise active processing nodes.

In some embodiments, the workloads comprise a plurality of workload elements (i.e., portions) distributed in the active nodes. For example, each workload may respectively include two or more workload elements, which may require/use different types of computing resources. In some embodiments, the number of migrations associated with the workloads is the number of migrations of the workload elements. In some embodiments, consolidating the workloads comprises migrating one or some of the workload elements from one or more of the active nodes to another one or more of the active nodes to reduce the number of active nodes. Preferably, the migration is in accordance with the type of computing resource required/used by the workload element (i.e., the migration is between same type of active nodes).

In some embodiments, the data center has a composable (disaggregated) architecture, in which each of the plurality of nodes respectively comprises one or more types of computing resource, and the plurality of nodes are arranged in a plurality of resource pools, the plurality of resource pools are isolated from each other. The types of computing resources may include: processing resource (e.g., CPU, GPU, FPGA, etc.), memory resource (includes volatile and/or non-volatile memory), storage resource (e.g., SSD), and/or communication resource (e.g., NIC).

In some embodiments, the plurality of nodes comprises a plurality of processing nodes each comprising processing resource (and optionally memory resource) and a plurality of memory nodes each comprising memory resource. For example, the plurality of processing nodes may include, e.g., CPU nodes comprising one or more CPUs, GPU nodes comprising one or more GPUs, and/or FPGA nodes comprising one or more FPGAs. For example, the plurality of memory nodes may include volatile memory nodes comprising volatile memory resource and/or non-volatile memory nodes comprising non-volatile memory resource.

In some embodiments, the active nodes comprise active processing nodes and active memory nodes. In some embodiments, consolidating the workloads comprises: migrating one or some of the workload elements from one or more of the active processing nodes to another one or more of the active nodes to reduce the number of active processing nodes and/or migrating one or some of the workload elements from one or more of the active memory nodes to another one or more of the active nodes to reduce the number of active memory nodes. Preferably, the migration is in accordance with the type of computing resource required/used by the workload element (i.e., the migration is between same type of active nodes).

In some embodiments, the plurality of nodes further comprises a plurality of storage nodes each comprising storage resource, and/or a plurality of communication nodes each comprising communication resource. For example., the plurality of storage nodes may include a plurality of network interface card (NIC) nodes comprising one or more NICs.

In some embodiments, the optimizing of the objective function is performed based least in part on a reinforcement learning method. For example, the reinforcement learning method is a Q-learning based reinforcement learning method.

In some embodiments, the Q-learning based reinforcement learning method comprises: receiving an input comprising value for the weight factor, initial placement of workload elements in the data center, start state, action set, and epoch number, and performing a learning operation based at least in part on the received input to determine an optimal placement of the workload elements in the data center.

In some embodiments, the learning operation is performed for a plurality of epochs, which may correspond to the epoch number.

In some embodiments, the learning operation comprises, in each epoch: obtaining a list including a plurality of possible actions, performing action selection operation to select action from the plurality of possible actions, performing an action application operation to apply the selected action to facilitate transition from a start state to a next state, performing a reward collection operation to obtain a reward in response to the transition, performing a Q-value update operation, and performing an optimal placement update operation.

In some embodiments, the reward is representable as

$$- A \times ( θ \cdot Δ {N}^{A c t} + ( 1 - θ ) \cdot Δ {N}^{M i g} )$$

where A is a constant, ΔN^{Act} is the change in the number of active nodes after the corresponding action is applied, and ΔN^{Mig} is the change in the number of migrations of the workload elements after the corresponding action is applied. For example, A=1.

In some embodiments, for each epoch, the start state corresponds to placement of workload elements that yields a minimum value of the objective function obtained so far in the learning operation.

In some embodiments, performing the action selection operation comprises determining feasibility of an action with respect to the workload element. The action selection operation is arranged to only select action that is determined to be feasible.

In some embodiments, if the action application operation migrates a workload element from a current resource pool to another resource pool, then the learning operation further comprises, in each epoch: updating the list in response to performing the action application operation, wherein updating the list comprises changing the list to include only actions arranged to migrate any workload elements belong to the same workload as the workload element to the another resource pool.

In some embodiments, if the action application operation does not migrate a workload element from a current resource pool to another resource pool, then the learning operation further comprises, in each epoch: updating the list in response to performing the action application operation, wherein updating the list comprises: removing, from the list, all actions associated with a workload element to which action has been applied; and removing, from the list, all actions associated with migrating workload elements belonging to the same workload as the workload element to one or more resource pools different from that of the workload element.

In some embodiments, the computer-implemented method further comprises displaying a representation of the plurality of Pareto optimal solutions.

In some embodiments, the computer-implemented method further comprises receiving a user input on a selection of one of the plurality of Pareto optimal solutions, and the consolidating of the workloads is based at least in part on the obtained information and the selected Pareto optimal solution.

In some embodiments, the computer-implemented method further comprises selecting one of the plurality of Pareto optimal solutions, and the consolidating of the workloads is based at least in part on the obtained information and the selected Pareto optimal solution. In one example, the selection may be based at least in part on a user input (which includes a selection). In another example, the selection may be based at least in part on predetermined rule(s) (e.g., based at least in part on any of: a predetermined number of active nodes required, a predetermined number of migrations allowed, a set amount or percentage of reduction of the number of active nodes, etc.).

In a second aspect, there is provided a system comprising one or more processors and memory storing a computer program configured to be executed by the one or more processors. The computer program comprises instructions for performing or facilitating performing of the computer-implemented method of the first aspect. Optionally, the system further comprises a display for displaying a representation of the Pareto optimal solutions. Optionally, the system further comprises an input device for receiving user input (e.g., user selection). The system may be incorporated in the data center or as part of the data centers.

In a third aspect, there is provided a carrier medium carrying computer readable instructions arranged to cause a computer to perform or facilitate performing of the computer-implemented method of the first aspect. In one example, the carrier medium comprises a computer-readable medium. In one example, the computer-readable medium is a non-transitory computer-readable storage medium, which stores a computer program configured to be executed by a computer. The computer program comprises instructions for performing or facilitating performing of the computer-implemented method of the first aspect.

In a fourth aspect, there is provided a computer program comprising instructions which, when the program is executed by a computer, cause the computer to carry out the computer-implemented method of the first aspect.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

As used herein, unless otherwise specified, terms of degree such that “generally”, “about”, “substantially”, or the like, are intended to account for manufacture tolerance, degradation, trend, tendency, imperfect practical condition(s), etc. Also, unless otherwise specified, the terms “connected”, “coupled”, or the like used herein are intended to encompass both direct and indirect connection, coupling, etc.

### BRIEF DESCRIPTION OF THE DRAWINGS

Some embodiments of the invention will now be described, with reference to the accompanying drawings, in which:

FIG. 1 is a flowchart illustrating a method for consolidating workloads in a data center in one embodiment of the invention;

FIG. 2A is a schematic diagram illustrating a data center with a server-based architecture in one embodiment of the invention;

FIG. 2B is a schematic diagram illustrating a data center with a composable (disaggregated) architecture in one embodiment of the invention;

FIG. 3 is a schematic diagram illustrating a Q-learning process in an example useful for understanding the invention;

FIG. 4 is a graph illustrating example Pareto fronts obtained based on integer linear programming (ILP) formulation in one embodiment of the invention;

FIG. 5A is a graph illustrating Pareto optimal solutions (number of active nodes vs number of migrations of workload elements) obtained based on different methods (ILP formulation and Q-learning (QL) based method) for a data center with a composable (disaggregated) architecture having 1 resource pool (1-pool) in one embodiment of the invention (ε=α=1);

FIG. 5B is a graph illustrating Pareto optimal solutions (number of active nodes vs number of migrations of workload elements) obtained based on different methods (ILP formulation and Q-learning (QL) based method) for a data center with a composable (disaggregated) architecture having 1 resource pool (1-pool) in one embodiment of the invention (slow decay of ε and α from 1.0 to 0.01);

FIG. 5C is a graph illustrating Pareto optimal solutions (number of active nodes vs number of migrations of workload elements) obtained based on different methods (ILP formulation and Q-learning (QL) based method) for a data center with a composable (disaggregated) architecture having 1 resource pool (1-pool) in one embodiment of the invention (fast decay of ε and α from 1.0 to 0.01);

FIG. 5D is a graph illustrating Pareto optimal solutions (number of active nodes vs number of migrations of workload elements) obtained based on different methods (ILP formulation and Q-learning (QL) based method, Simulated Annealing, First-Fit (FF) method, First-Fit Decreasing (FFD) method) for a data center with a composable (disaggregated) architecture having 1 resource pool (1-pool) in one embodiment of the invention (“comprehensive” setting: i.e., combined use of fast-decay and slow-decay strategies for ε and α);

FIG. 6A is a graph illustrating Pareto optimal solutions (number of active nodes vs number of migrations of workload elements) obtained based on different methods (ILP formulation and Q-learning (QL) based method, Simulated Annealing, First-Fit (FF) method, First-Fit Decreasing (FFD) method) for a data center with a composable (disaggregated) architecture having 5 resource pools (5-pool) in one embodiment of the invention (“comprehensive” setting: i.e., combined use of fast-decay and slow-decay strategies for ε and α);

FIG. 6B is a graph illustrating Pareto optimal solutions (number of active nodes vs number of migrations of workload elements) obtained based on different methods (ILP formulation and Q-learning (QL) based method, Simulated Annealing, First-Fit (FF) method, First-Fit Decreasing (FFD) method) for a data center with a composable (disaggregated) architecture having 10 resource pools (10-pool) in one embodiment of the invention (“comprehensive” setting: i.e., combined use of fast-decay and slow-decay strategies for ε and α);

FIG. 7A is a graph illustrating the sensitivity of the weight factor θ (number of active nodes and number of migrations of workload elements, for different weight factor values) in the Q-learning (QL) based method in one embodiment of the invention;

FIG. 7B is a graph illustrating the amount of running time for different number (amount) of workloads in one embodiment of the invention; and

FIG. 8 is a block diagram illustrating an example information handling system operable to perform the method in one or more embodiments of the invention.

### DETAILED DESCRIPTION

Some embodiments of the invention provide a technique or tool for consolidating workloads in a data center (such as but not limited to a data center with composable architecture).

A data center may include many machines, which can be referred to as hardware or nodes. These machines can be operated to run applications and provide IT services including digital data computing, storage, and exchanging. Typically, these machines include, among other things, dedicated computers (often referred to as servers). Each server includes different types of resources, including computing devices (e.g., CPU, GPU, FPGA, etc.), memory devices (e.g., DRAM and SRAM), storage devices (e.g., HD and SSD), and networking devices (e.g., network interface card (NIC)). These resources are integrated with a common motherboard and are arranged in a chassis.

In data center with a sever-based architecture (traditional), different servers in the data center are independent such that, e.g., a CPU in one server cannot access memory in another server.

In data center with a composable architecture, different devices/resources are operably decoupled from independent servers and are reassembled into shared resource pools, e.g., computing pool and memory pool. This enables flexible system composability. For example, a certain combination of computing, memory, storage, and networking devices can be flexibly selected to form a system. If needed, the selected memory device can be replaced with a different one. Interconnect technique such as CXL may be employed for communication between different types of devices. Also, to address networking issues, modifications, e.g., retaining a small amount of memory on each computing node, and limiting the size of resource pools is limited, etc., can be made.

Workload consolidation relates to resource management in data centers and it can be used to improve resource utilization by rearranging workloads spread or distributed over a larger number of hardware/nodes onto a smaller number of hardware/nodes.

As used herein, a data center with a server-based architecture is also referred to as a server-based data center (SDC). The term server-based architecture can also be referred to as server-based infrastructure. As used herein, a data center with a composable or disaggregated infrastructure (CDI) is also referred to as a CDI-based data center (CDC). The term composable or disaggregated infrastructure can also be referred to as composable or disaggregated architecture. Further, as used herein, the term “element”, when described with refence to a workload, or the term “workload element”, refers to a part or a portion of the workload.

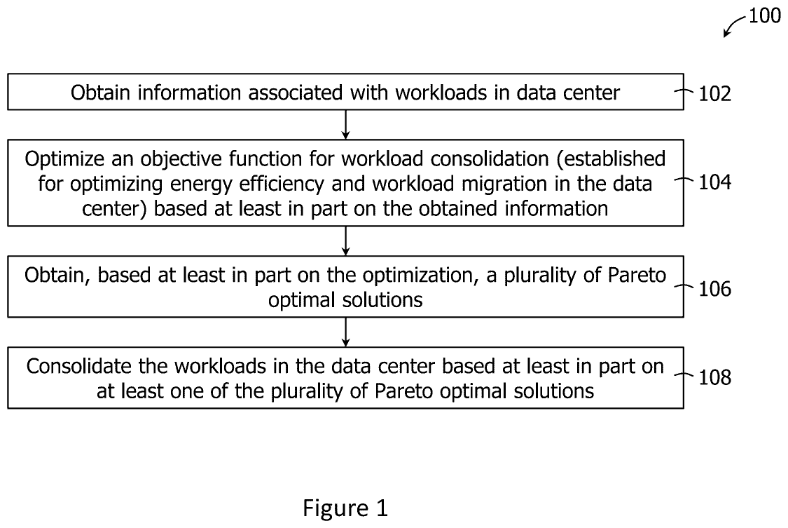

FIG. 1 shows a method 100 for consolidating workloads in a data center in one embodiment of the invention. The workloads include computation tasks that are arranged to be performed using one or more types of computing resource. In this embodiment, the method 100 is a computer-implemented method. In one example, the method 100 may be used for consolidating workloads in a data center with a server-based architecture. In one example, the method 100 may be used for consolidating workloads in a data center with a composable or disaggregated architecture.

The method 100 includes, in 102, obtaining (e.g., receiving) information associated with workloads, in particular existing workloads being processed, in the data center. The information may include the details/nature of the workloads, the progress of the workloads, the resource requirements of the workloads, the relationship between any of the workloads (if any), the distribution of the workloads in the data center, etc.

The method 100 also includes, in 104, optimizing an objective function for workload consolidation based at least in part on the obtained information. In this embodiment, the objective function is established for optimizing energy efficiency and workload migration in the data center. In one example, the objective function is established to optimize the energy efficiency and the workload migration by maximizing the energy efficiency and minimizing the number of migrations associated with the workloads.

In one example, the data center includes multiple nodes each respectively including one or more types of computing resource. The nodes may include active nodes and inactive nodes (e.g., if not all nodes are active nodes). Active nodes are nodes that are handling workload(s) or workload element(s) (portion(s)). The workloads are distributed in the active nodes. In this example, the objective function is established to optimize the energy efficiency and the workload migration by minimizing the number of active nodes in the data center and minimizing the number of migrations associated with the workloads. For example, the objective function can be represented as:

$$θ \cdot {N}^{A c t} + ( 1 - θ ) \cdot {N}^{M i g}$$

where N^{Act} is the number of active nodes, N^{Mig} is the number of migrations associated with the workloads, and θ∈[0, 1] is a weight factor. In this case, the optimization of the objective function may include applying different weight factors (i.e., different values of the weight factor θ) to the objective function to minimize the objective function.

In this embodiment, in 104, the optimization of the objective function may be performed based least in part on a reinforcement learning method such as a Q-learning based reinforcement learning method. Other methods, such as method based on ILP formulation, may alternatively be used to optimize the objective function.

The method 100 also includes, in 106, obtaining, based at least in part on optimizing the objective function, a set of Pareto optimal solutions. Each Pareto optimal solution respectively represents an optimal energy efficiency for a corresponding number of migrations associated with the workloads or an optimal number of migrations associated with the workloads for a corresponding energy efficiency.

The method 100 also includes, in 108, consolidating the workloads in the data center based at least in part on at least one of the Pareto optimal solutions.

In one example, the number of migrations associated with the workloads is the number of migrations of the workloads. In this case, in 108, consolidating the workloads includes migrating one or some of the workloads from one or more of the active nodes to another one or more of the active nodes to reduce the number of active nodes. The migration may be in accordance with the type of computing resource required/used by the workload (i.e., the migration is between same type of active nodes).

In one example, the workloads include multiple workload elements (i.e., portions) distributed in the active nodes. For example, each workload may respectively include two or more workload elements, which may require/use different types of computing resources. In one example, the number of migrations associated with the workloads is the number of migrations of the workload elements. In this case, in 108, consolidating the workloads includes migrating one or some of the workload elements from one or more of the active nodes to another one or more of the active nodes to reduce the number of active nodes. The migration may be in accordance with the type of computing resource required/used by the workload element (i.e., the migration is between same type of active nodes).

As mentioned, the method 100 may be used for consolidating workloads in a data center with server-based architecture. In such a data center, each of the nodes is respectively associated with a server having different types of computing resources. For example, the types of computing resources may include processing resource (e.g., CPU, GPU, FPGA, etc.), memory resource (includes volatile and/or non-volatile memory), storage resource (e.g., SSD), and/or communication resource (e.g., NIC). For example, the nodes may include processing nodes each including processing resource (and optionally memory resource), and the active nodes include active processing nodes.

As mentioned, the method 100 may be used for consolidating workloads in a data center with composable (disaggregated) architecture. In such a data center, each of the nodes respectively includes one or more types of computing resource, and the nodes are arranged in multiple resource pools isolated from each other. For example, the types of computing resources may include processing resource (e.g., CPU, GPU, FPGA, etc.), memory resource (includes volatile and/or non-volatile memory), storage resource (e.g., SSD), and/or communication resource (e.g., NIC). In one example, the nodes include processing nodes each including processing resource (and optionally memory resource) and memory nodes each including memory resource. For example, the processing nodes may include, e.g., CPU nodes including one or more CPUs, GPU nodes including one or more GPUs, and/or FPGA nodes including one or more FPGAs. For example, the memory nodes may include volatile memory nodes including volatile memory resource and/or non-volatile memory nodes including non-volatile memory resource. In one example, the nodes further include storage nodes each including storage resource, and/or communication nodes each including communication resource. For example, the storage nodes may include network interface card (NIC) nodes including one or more NICs. In one example, the active nodes include active processing nodes and active memory nodes. In such case, in 108, consolidating the workloads includes migrating one or some of the workload elements from one or more of the active processing nodes to another one or more of the active nodes to reduce the number of active processing nodes and/or migrating one or some of the workload elements from one or more of the active memory nodes to another one or more of the active nodes to reduce the number of active memory nodes. The migration may be in accordance with the type of computing resource required/used by the workload element (i.e., the migration is between same type of active nodes).

In one example, the method 100 may further include displaying a representation of the Pareto optimal solutions.

In one example, the method 100 may further include receiving a user input on a selection of one of the Pareto optimal solutions, and the consolidating of the workloads is based at least in part on the obtained information and the selected Pareto optimal solution.

In one example, the method 100 may further include selecting one of the Pareto optimal solutions, and the consolidating of the workloads is based at least in part on the obtained information and the selected Pareto optimal solution. The selection may be based at least in part on a user input (which includes a selection) or based at least in part on predetermined rule(s) (e.g., based at least in part on any one or more of: a predetermined number of active nodes required, a predetermined number of migrations allowed, a set amount or percentage of reduction of the number of active nodes, etc.). In one example the selection may be performed automatically based on the predetermined rule(s) and the workload consolidation may be performed more readily.

In one example, in 104, the optimization of the objective function is performed using a Q-learning based reinforcement learning method. In one example, the Q-learning based reinforcement learning method includes receiving an input comprising value for the weight factor, initial placement of workload elements in the data center, start state, action set, and epoch number, and performing a learning operation based at least in part on the received input to determine an optimal placement of the workload elements in the data center. For example, the learning operation may be performed for a plurality of epochs, in accordance with the epoch number (e.g., if the epoch number is 1000, then 1000 epochs are performed in the learning operation).

In one example, the learning operation includes, in each epoch: obtaining a list including a plurality of possible actions, performing action selection operation to select action from the plurality of possible actions, performing an action application operation to apply the selected action to facilitate transition from a start state to a next state, performing a reward collection operation to obtain a reward in response to the transition, performing a Q-value update operation, and performing an optimal placement update operation.

In one example, the reward may be represented as

$$- A \times ( θ \cdot Δ {N}^{A c t} + ( 1 - θ ) \cdot Δ {N}^{M i g} )$$

where A is a constant, AN Act is the change in the number of active nodes after the corresponding action is applied, and AN^{Mig} is the change in the number of migrations of the workload elements after the corresponding action is applied.

Preferably, for each epoch, the start state corresponds to placement of workload elements that yields a minimum value of the objective function obtained so far in the learning operation.

In one example, performing the action selection operation includes determining feasibility of an action with respect to the workload element.

In one example, if the action application operation migrates a workload element from a current resource pool to another resource pool, then the learning operation further includes, in each epoch: updating the list in response to performing the action application operation. The update includes changing the list to include only actions arranged to migrate any workload elements belong to the same workload as the workload element to the another resource pool.

In one example, if the action application operation does not migrate a workload element from a current resource pool to another resource pool, then the learning operation further comprises, in each epoch: updating the list in response to performing the action application operation. The update includes removing, from the list, all actions associated with a workload element to which action has been applied, and removing, from the list, all actions associated with migrating workload elements belonging to the same workload as the workload element to one or more resource pools different from that of the workload element.

A skilled person appreciates that various modifications may be made to the method 100 to provide other embodiments of the invention.

The following disclosure provides some more-specific embodiments of the invention. These more-specific embodiments are based at least in part on the method 100.

Inventors of the present invention have found that migration associated with workloads in a data center may be different for different types of data centers. For example, in data center with server-based architecture (SDC), a workload may be processed by one server (which has different types of computing resources), and the workload must be migrated as a whole. For example, in data center with composable or disaggregated architecture (CDC), a workload may be distributed in multiple nodes for different types of resources (i.e., the workload may be divided into multiple workload parts (also called workload elements) each using a respective node), and the workload elements (workload parts or portions) may be migrated independently. In one example, the partial migration of a workload (i.e., the migration of one or more workload elements) may be realized using the resource reassignment ability of Compute Express Link (CXL) (version 2.0 or above). On the other hand, operating system (OS) such as LegoOS as disclosed in Shan et al., “LegoOS: A disseminated, distributed OS for hardware resource disaggregation” (2008) enables combination of different OS functionalities according to application requirements, thus providing support for migration of individual workload elements. In some cases, compared to migration of a workload in its entirety (i.e., as a whole), partial migration of a workload can provide more flexibility for workload consolidation and may help reduce the migration cost incurred in workload consolidation.

Inventors of the present invention have found, through their research, that existing methods for workload consolidation and energy-efficient resource management in data centers are primarily designed for data centers with server-based architecture (SDCs) and not data center with composable or disaggregated infrastructure (CDCs).

Against this background, the following disclosure focuses on workload consolidation in CDCs. However, it should be noted that workload consolidation methods in some embodiments of the invention may also be used, or adapted for use, in workload consolidation in SDCs or in data centers with other types of architecture.

As an overview, in one embodiment related to workload consolidation in CDCs (disclosed below), the objectives are to minimize the number of active nodes and reduce the number of migrated elements (i.e., the number of migrations of workload elements). In this embodiment, a Q-learning based method is applied to address the workload consolidation problem, and the above bi-objective problem is converted into a single objective problem by employing a weighted sum approach. The method can be applied to generate an approximate Pareto front by varying the weight factor values. To validate the performance of this embodiment, an Integer Linear Programming (ILP) formulation is applied to obtain an optimal Pareto front (for comparison with the approximate Pareto front obtained using the Q-learning based method). Although the ILP formulation is NP-hard and not scalable for large-scale problems, it may provide optimal solutions for small-scale scenarios with the support of commercial solvers. As will be described in greater detail below, it has been found that the Q-learning based method in this embodiment can closely approximate the ILP Pareto fronts across various test cases. Further, it has been found that the Q-learning based method in this embodiment provides better performance than a baseline method implemented using Simulated Annealing (SA) and various traditional heuristic methods such as First Fit (FF) algorithm and First Fit Decreasing (FFD) algorithm. Compared with these traditional heuristic methods, the Q-learning based method in this embodiment can more effectively optimize the number of active nodes and the number of migrated elements.

Inventors of the present invention have also discovered, through their research, that while various techniques or methods related to CDCs exist, there is currently no or limited techniques/methods for resource allocation, in particular workload consolidation, in CDCs. In particular, there is currently no or limited technique/method arranged to optimize (i.e., trade-off between) energy efficiency and workload migration costs. Accordingly, inventors of the present invention have devised a method for consolidating workloads in a data center (such as a CDC), which involves determining Pareto fronts. These Pareto fronts may offer operators the flexibility to select solution(s) tailored to their preferences and/or requirements.

Details of one embodiment of the invention will now be described.

First, the problem statement in this embodiment is presented. The following provides an overview of different data center architectures and presents the problem description.

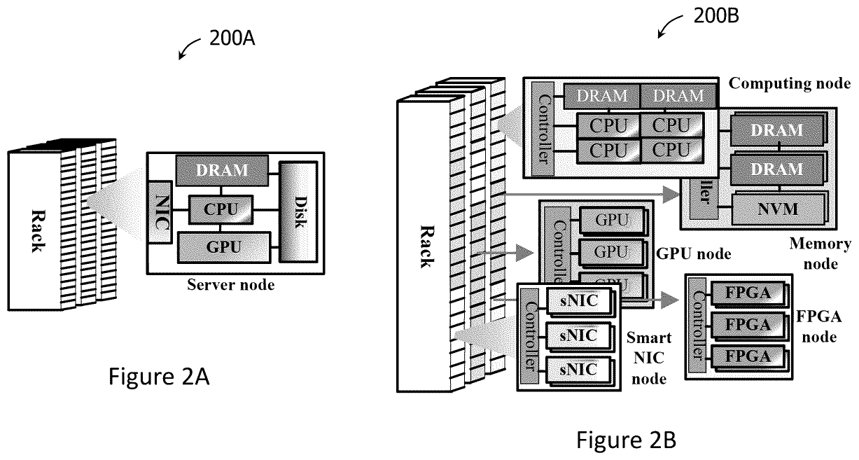

FIG. 2A illustrates a data center 200A with a server-based architecture in one embodiment of the invention. As shown in FIG. 2A, the data center 200A in this embodiment includes multiple server racks each including multiple servers (e.g., rack servers and/or blade servers). Each of the servers provide a respective node (served node) of the data center 200A such that each node includes different types of computing resources. In the example of FIG. 2A, these different types of computing resources includes processing resource (central processing unit (CPU) and graphics processing unit (GPU)), memory resource (dynamic random access memory (DRAM)), communication resource (network interface card (NIC)), and storage resource (disk).

FIG. 2B illustrates a data center 200B with a composable (disaggregated) architecture in one embodiment of the invention. As shown in FIG. 2B, the data center 200B in this embodiment includes multiple server racks each including multiple servers (e.g., rack servers and/or blade servers). The data center 200B includes multiple nodes, in particular multiple types of nodes each including different computing resources, collectively provided by the servers. In the example of FIG. 2B, the nodes include computing node (includes CPUS, DRAMs, and controller), memory node (includes DRAM, non-volatile memory (NVM), and controller), field programmable gate arrays (FPGA) node (includes FPGAs and controller), smart NIC (sNIC) node (includes smart NICs and controller), and GPU node (includes GPUS and controller).

In the example of FIG. 2B, a node may include a primary resource and a secondary resource. For example, the computing node includes not only CPU(s) but also memory modules that serve as local memory. This is sensible because in practice, it may be difficult if not impossible to completely disaggregate memory from processors (e.g., CPUs). In this embodiment, local memory is not excluded from resource allocation considerations and is instead an allocable resource (the memory in memory nodes is considered as a memory expansion). In this embodiment, however, a memory node may also include computing capability, which is considered to be reserved for the controller or monitor hence is not available for allocation.

Due to the high bandwidth and low latency communication requirements between different resource modules, it may not be practical to aggregate resources in a large-scale data center into a single resource pool. Thus, in this embodiment, a practical approach is applied to divide the resource modules into multiple resource pools, where different resource pools are isolated from each other. The size of each resource pool, or disaggregation scale, is a parameter related to the number of nodes contained in each resource pool. One example disaggregation scale is the rack scale, where resource modules in one or several racks form a resource pool. Nevertheless, CXL (version 3.0) can also support pod scale disaggregation. In this disclosure, the impact of the disaggregation scale on the workload consolidation performance is considered.

In this embodiment, the problem of workload consolidation in CDCs can be described as follows.

First, there exists a CDC including various types of nodes organized into multiple resource pools. Each node has certain capacities for one or multiple types of resources. Additionally, a set of workloads and their current placements are arranged in the CDC. Each workload includes multiple workload elements, each assigned to a different node. In this embodiment, the objective is to consolidate the existing workloads to maximize energy efficiency while minimizing the costs associated with workload migration. In one embodiment, maximizing energy efficiency may involve incorporating an appropriate power model to capture the power profiles of each resource node. However, this embodiment considers a simpler case, which focuses on minimizing the number of active nodes (as a way to minimize energy consumption). Similarly, this embodiment aims to minimize the number of migrated elements (i.e., number of migrations of workload elements) as a way to reduce the associated migration costs.

In this embodiment, a weighted sum approach is applied to address the two-objective problem with the following objective function:

$$Minimize : θ \cdot {N}^{A c t} + ( 1 - θ ) \cdot {N}^{M i g} \qquad ( 1 )$$

where N^{Act} is the number of active nodes, N^{Mig} is the number of migrated elements, and θ∈[0, 1] is the weight factor. The constraints include ensuring that each workload element uses only one resource node of the same type as its original host, maintaining the same amount of resources provisioned after the consolidation, placing all workload elements of each workload in a the same resource pool, and accounting for resource capacity restrictions.

The objective function in this embodiment is the weighted sum of the number of active nodes and the number of migrated elements, and as such, it incorporates both energy cost and quality of service (QOS) aspects. In some cases, workload migration involves downtime which may adversely affect QOS. It may thus be challenging to obtain optimal weights for the two objectives. In this embodiment, this challenge is addressed by determining and providing the Pareto front, which offers a range of optimal results for the two objectives, namely, it provides the minimum number of migrated elements (i.e., number of migrations of workload elements) for any given number of active nodes and the minimum number of active nodes for a given number of migrated elements (i.e., number of migrations of workload elements). In this way, each point on the Pareto front represents a solution, which is an optimal trade-off between the two objectives. By presenting the Pareto front to users (e.g., decision-makers and stakeholders), the users can choose their preferred solution based on their preferences.

The Q-Learning based solution in one embodiment will now be described. The following provides an overview on Q-learning in general and details the Q-learning based algorithm in this embodiment.

Q-learning is a known reinforcement learning algorithm designed to make sequential decisions in uncertain environments through iterative learning, and it has proven to be effective for solving Markov Decision Processes (MDPs). MDPs are problem models that incorporate “state”, “action”, “reward”, and “transition”. The state represents the current system or environment configuration. By applying an action, the system transitions to a new state and receives a reward.

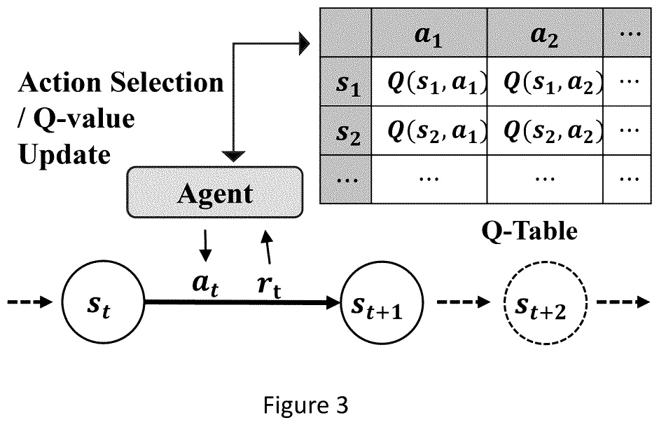

FIG. 3 depicts an example process of Q-learning. In state sₜ, the system offers a range of candidate actions. The agent, responsible for learning and decision-making, chooses action at to execute. The system then executes the chosen action and transitions to state sₜ₊₁, and the agent receives reward rₜ.

The Q-value is a pivotal metric that guides action selection based on the cumulative reward of taking a specific action in a given state. These Q-values for different state-action pairs can be stored in a table known as the Q-table. During action selection, Q-learning employs the exploitation and exploration strategy, commonly referred to as the ε-greedy method, where ε represents the exploration factor. In this strategy, the agent randomly selects an action with a probability of ε (ε∈(0,1)), and selects the action with the highest Q-value with a probability of 1−ε. Upon receiving a reward, the Q-value is updated using the Bellman optimality equation as follows:

$$Q ( {s}_{t} , {a}_{t} ) = ( 1 - α ) \cdot Q ( {s}_{t} , {a}_{t} ) + α \cdot ( {r}_{t} + γ \cdot {max}_{a} [ Q ( {s}_{t + 1} , a ) ] ) \qquad ( 2 )$$

In equation (2), Q(sₜ,aₜ) on the right-hand side is the old Q-value of the state-action pair (sₜ,aₜ), representing the past experience; the term

$${max}_{a} [ Q ( {s}_{t + 1} , a ) ]$$

is the maximum Q-value of the next state, representing the estimated maximum future reward if the agent always selects the action with highest Q-value from the next state (sₜ₊₁) onwards; γ is discount factor, which indicates the importance of future rewards relative to immediate rewards; and α is learning rate, which provides a weight between the new information (immediate plus future rewards) and existing knowledge. A larger α can drive the agent more towards exploring new experiences. The fundamental element of the learning process is called a step. In each step, the agent sequentially executes the action selection, action application, reward collection, and Q-value update. Accordingly, the system experiences a state transition. A full iteration of the learning algorithm, commonly referred to as an epoch, involves many steps, and many epochs are required to achieve satisfactory performance.

In this embodiment, there is provided a Q-learning based workload consolidation algorithm for consolidating workloads in CDCs. The Q-learning based workload consolidation algorithm is based on (modified from) the above discussed Q-learning technique.

Definition of various terms in this embodiment is first provided.

In this embodiment, relative terms for applying Q-learning to workload consolidation in CDCs are defined as follows.
State: In this embodiment, to ensure a compact state space, the state is defined as N^{Act}, which represents the number of active nodes.
Action: In this embodiment, the action is defined as moving a certain workload element to a certain node. This node must be the same node type as its original host (node). In this embodiment an action can be represented as:

$${a}_{t} = ( {e}_{t} , {n}_{t} ) \qquad ( 3 )$$

where eₜ is the element of node type t and nₜ is the destination node of node type t.
Reward: In this embodiment, the reward is defined as the negative change in the objective function:

$$reward = - 1 \times ( θ \cdot Δ {N}^{A c t} + ( 1 - θ ) \cdot Δ {N}^{M i g} ) \qquad ( 4 )$$

where ΔN^{Act} is the change in the number of active nodes and ΔN^{Mig} is the change in the number of migrated elements (the number of migrations of the workload elements), both after the corresponding action is applied. Accordingly, in this embodiment, actions that may decrease the number of active nodes and the number of migrated elements can yield higher rewards and actions that may not decrease the number of active nodes and the number of migrated elements can yield lower rewards.

The Q-learning based workload consolidation algorithm in this embodiment is based on the principles of Q-learning and incorporates several modifications considering the characteristics of the problem.

One modification relates to a dynamic action space.

In this embodiment, an element (workload element) can take only one action per epoch, i.e., either stay in its current host (node) or migrate to another node. In this regard, the Q-learning based workload consolidation algorithm in this embodiment dynamically adjusts the action space. Specifically, after an element (eₜ) has taken its initial action, all actions associated with this element are removed from the action space, e.g., using the following operation:

$${L}_{c u r} . \text{remove} ( \{ a ∈ A : e ( a ) = {e}_{t} \} )$$

where A is the set of all possible actions, L_{cur} is the current action list, and e (.) is the function that retrieves the element associated with the action a (See Table I). This operation ensures that no further actions involving the same element will occur again in this epoch. At the beginning of the next epoch, L_{cur} is reset to include all possible actions, allowing each element to choose its action for the new epoch.

In addition, to ensure that all the elements of each workload are in a common resource pool, actions that involve moving “brother” elements of the current element eₜ (i.e., the “brother” elements are elements belonging to the same workload as element eₜ) into resource pools different from the destination resource pool of the et are removed. For example, let at be the current action. The operation can be:

$${L}_{c u r} . remove ( \{ a ∈ A : e ( a ) \neq {e}_{t} , w ( e ( a ) ) = w ( {e}_{t} ) , p ( a ) \neq p ( {a}_{t} ) \} )$$

where w(·) and p(·) are the functions defined in Table I. After performing this operation, all brother elements of eₜ will be moved into resource pool p(aₜ) later in the current epoch.

When a workload moves to another resource pool, there may be a situation where its “first” element is successfully migrated, but one or more “subsequent” elements (of the same workload) fail to migrate due to lack of resources. Here, the “first” element refers to the element that is the earliest in terms of its appearance among all the elements of the workload in an epoch. In other words, it is the element that first appears in an action within that epoch. In this embodiment, it would be necessary to check whether the destination resource pool can accommodate all the elements before moving the first element of this workload, and if this resource pool is not feasible, it would be necessary to exclude this pool by removing actions that try to move elements of the current workload w(eₜ) to the infeasible resource pool p(aₜ), e.g., by executing the following operation, i.e.,

$${L}_{c u r} . remove ( \{ a ∈ A : w ( e ( a ) ) = w ( {e}_{t} ) , p ( a ) = p ( {a}_{t} ) \} )$$

However, after migrating the first element of this workload to a different resource pool, the agent may subsequently choose actions on other workloads rather than the brother elements of this first element. Consequently, the resource pool initially determined as feasible might become infeasible for these brother elements because this resource pool may allocate resources to other workloads in the subsequent steps. To avoid this, in this embodiment, the agent is arranged to select actions on these brother elements after migrating this first element. Note that this situation will not occur when this first element does not change its resource pool, and its current resource pool is always feasible for its brother elements since they can at least stay in their current host.

In this embodiment, the process is differentiated into normal period, when the workload stays in its current resource pool, and exception period, when the workload is going to move to a different resource pool. When the agent is going to move the first element to a different resource pool, the exception period starts. In this period, the action space is temporarily changed to a new list that contains only the actions that aim to migrate any element(s) of this workload to this destination resource pool. Then, the agent will consecutively apply actions on this workload. After all the elements of this workload are successfully moved, the exception period is completed and the normal period resumes.

Another modification relates to the start state of each epoch.

In the Q-learning based workload consolidation algorithm in this embodiment, each epoch is set to start from the ever-optimal state where the placement of elements yields the minimum value of the objective function recorded thus far. This choice of starting state is based on an observation that it consistently leads to better performance than starting each epoch from either the last state in the previous epoch or the given initial state.

Another modification relates to the result output.

Traditional Q-learning executes a learning process (learning operation) to obtain a stable Q-table, which will be used as the guide for new applications. In this embodiment, however, the purpose is to find the optimal placement for the given problem hence the traditional way is not followed. Instead, this embodiment records and obtains the optimal placement, which results in the lowest objective function throughout the learning process, and outputs it as the final result.

Algorithm 1 below provides an example pseudocode of the Q-learning based workload consolidation algorithm in this embodiment (as described above). Table I presents some of the functions used in Algorithm 1.

Algorithm 1 - Q-learning based workload consolidation algorithm in one embodiment

Input: θ, ϕ₀, s₀, A, N^{Epk} // weight factor, initial element placement, initial state, action set, and
epoch number
Output: The optimal placement

| | |
|---|---|
| 1: except = false; | // global indicator for exception handling |

```
  2: obj^{min} = ∞; ϕ^{opt} = ϕ₀;
  3: for (k = 0; k < N^{Epk}; k + +)
```

| 4: | L₀ = { }; L₀. add(A) | // add all actions |
|---|---|---|
| 5: | L_{cur} = L₀; | // pointer L_{cur} points to L₀ |
| 6: | sₜ = s(ϕ^{opt}); | // start from optimal placement |
| 7: | while (\|L_{cur}\| > 0) | |
| 8: | aₜ = ε-GRE(L_{cur}); | // get a feasible action |
| 9: | if (aₜ == null) break; | |
| 10: | if (!UPD-ACT-LIS(aₜ)) continue; | |
| 11: | ϕ₁, sₜ₊₁, r = APP-ACT(aₜ); | // apply aₜ |
| 12: | UPD-Q-TAB(aₜ,sₜ,r,sₜ₊₁); | // update Q-table |
| 13: | if (!except && obj(ϕ1) < obj^{min}) | |
| 14: | ϕ^{opt} = ϕ₁; obj^{min} = obj; | |
| 15: | return ϕ^{opt}; | |
| 16: | procedure UPD-ACT-LIS(aₜ) | // Note: aₜ = (eₜ, nₜ) |
| 17: | if (!except) | // normal period |
| 18: | if (p(eₜ) == p(aₜ)) | // if kept in current pool |
| 19: | L_{cur}. remove({a ∈ A : e(a) = eₜ}); | |
| 20: | L_{cur}. remove({a ∈ A : e(a) ≠ eₜ, w(e(a)) = w(eₜ),p(a) ≠ p(aₜ)}); | |
| 21: | else | // if move to another pool |
| 22: | if (!p(eₜ). feasible(w(eₜ)) | |
| 23: | L_{cur}. remove({a ∈ A : w(e(a)) = w(eₜ),p(a) = p(aₜ)}); | |
| 24: | return false; // lack of resource | |
| 25: | else | |
| 26: | L_{cur}. remove({a ∈ A : w(a) = w(eₜ)}); | |
| 27: | L₁ = {a ∈ A : w(e(a)) = w(eₜ),p(a) = p(eₜ)}; // a new list | |
| 28: | L_{cur} = L₁; | // L_{cur} points to the new list |
| 29: | except = true; | // enter exception period |
| 30: | else | // in exception period |
| 31: | L_{cur}. remove({a ∈ A : e(a) = eₜ}); | |
| 32: | if (\|L_{cur}\| == 0) | |
| 33: | L_{cur} = L₀; | // L_{cur} back to L₀ |
| 34: | except = false; | // exit exception period |

| | |
|---|---|
| 35: | return true; |

TABLE I
Functions used in the pseudocode in Algorithm 1

| | |
|---|---|
| e(•) | Return the element associated with the given action “•” |
| w(•) | Return the workload to which the element “•” belongs |
| p(•) | If “•” is an element, return the pool where “•” is currently |
| | located; If “•” is an action, return the pool towards which |
| | the action attempts to move a certain element |
| s(•) | Reset the system to the given placement “•” and return |
| | the state value |
| obj(•) | Return the objective value based on placement “•” |
| L. add(•) | Add actions from the action set “•” to the list L |
| L. remove(•) | Remove actions from the action set “•” from the list L |

Algorithm 1 will now be described.

Referring to Algorithm 1, the necessary global variables are initialized (lines 1-2), where ϕ^{opt} represents the optimal placement and is initialized as the initial placement ϕ₀. The main body of the algorithm is executed in a for-loop (lines 3-14), with the number of iterations determined by the input N^{Epk}, which is the number of epochs. In each epoch, a new list L₀ is created, and all possible actions are added to this list (line 4). Additionally, a variable L_{cur} is introduced as a pointer to the current action list, initialized as L₀ (line 5). The while-loop completes action selection (lines 8 and 9), action application (line 11), reward collection (line 11, where r represents the reward), and Q-value update (line 12). During the action selection phase (line 8), the feasibility of an action is checked by ensuring that a node has sufficient resources to accommodate the element associated with that action.

In Algorithm 1, line 10 involves updating the action list by calling the procedure UPD-ACT-LIST (aₜ), outlined in lines 16-35. This procedure is the implementation of the dynamic action space as explained above. Briefly, the action list is updated based on whether it is in the normal period (lines 17-29) or in the exception period (lines 30-34). In the normal period, the algorithm will further check whether the action will keep the element in the current pool (lines 18-20) or move it to another pool (lines 21-29). If attempting to move it to another pool but it cannot provide sufficient resources for its brother elements (line 22), the algorithm returns a false flag, indicating that this action is infeasible. The main function will proceed with the next action (line 10). If the pool is feasible, the algorithm updates L_{cur} to point to a new list L₁ and informs the main function to enter the exception period (line 29) for consecutively migrating all elements of the same workload to the designated destination pool. The exception period concludes when all elements have been migrated, and L_{cur} is reset to point to L₀ (lines 32-34). In this example, the optimal placement is updated (lines 13-14) only in the normal period, i.e., when except==false (line 13). This is because updating the optimal placement during the exception period may result in elements of a workload being located in different pools.

A complexity analysis is now provided.

Analyzing the time or computational complexity of the Q-learning based algorithm can be challenging as it may be impacted by many factors, such as the sizes of state space and action space, the hyper-parameter settings (such as the learning rate α, exploration rate ε, and discount factor γ), the computational complexity of the reward function, and the number of epochs needed for convergence. In this example, considering that the number of epochs is denoted by N^{Epk} and each epoch involves each element taking one action, a rough estimate of the complexity of Algorithm 1 is provided as 0(N^{Epk}·NE), where NE denotes the number of elements. The space complexity is determined by the size of the Q-table, which is the product of the state space size and the action space size. Let NR represent the number of resource nodes. Then, the state space size is NR, and the action space size is NE·NR. Consequently, the space complexity is 0(NR²·NE).

An integer linear programming (ILP) formulation utilized to generate the necessary ILP solutions in one embodiment is now described.

Table II contains the definitions of all sets, parameters, and decision variables in this ILP formulation embodiment. In this ILP formulation embodiment, the objective function is defined in equation (1), and the constraints are:

$$\begin{matrix}{\sum }_{n ∈ {N}_{t}} {x}_{n t}^{v} = {\sum }_{n ∈ {N}_{t}} {η}_{n t}^{v} & ∀ v ∈ V , t ∈ T\end{matrix} \qquad ( 5 )$$

$$\begin{matrix}{\sum }_{p ∈ P} {y}_{v p} = 1 & ∀ v ∈ V\end{matrix} \qquad ( 6 )$$

$$\begin{matrix}{y}_{v p} \leq {\sum }_{n ∈ {N}_{t}} {x}_{n t}^{v} \cdot {π}_{n t}^{p} & ∀ v ∈ V , t ∈ T , p ∈ P\end{matrix} \qquad ( 7 )$$

$$\begin{matrix}{y}_{v p} \geq {x}_{n t}^{v} \cdot {π}_{n t}^{p} & ∀ v ∈ V , n ∈ {N}_{t} , t ∈ T , p ∈ P\end{matrix} \qquad ( 8 )$$

$$\begin{matrix}{z}_{n t} \geq {x}_{n t}^{v} & ∀ n ∈ {N}_{t} , t ∈ T , v ∈ V\end{matrix} \qquad ( 9 )$$

$$\begin{matrix}{z}_{n t} \leq {\sum }_{v ∈ V} {x}_{n t}^{v} & ∀ n ∈ {N}_{t} , t ∈ T\end{matrix} \qquad ( 10 )$$

$$\begin{matrix}{\sum }_{v ∈ V} {D}_{r t}^{v} \cdot {x}_{n t}^{v} \leq {c}_{n t}^{r} & r ∈ R , n ∈ {N}_{t} , r ∈ {R}_{t} , t ∈ T\end{matrix} \qquad ( 11 )$$

$${N}^{A c t} = {\sum }_{n ∈ {N}_{t} , t ∈ T} {z}_{n t} \qquad ( 12 )$$

$${N}^{M i g} = {\sum }_{v ∈ V , n ∈ {N}_{t} , t ∈ T} {η}_{n t}^{v} \cdot ( 1 - {x}_{n t}^{v} ) \qquad ( 13 )$$

TABLE II
Sets, parameters, and decision variables for the ILP formulation in one
embodiment
Sets

| | |
|---|---|
| T | The set of node types |
| Rₜ | The set of resource types provided by each node of node type t (t ∈ T), e.g., a |
| | compute node provides (CPU) cores and local memory |
| Nₜ | The set of nodes of node type t |
| V | The set of workloads |
| P | The set of resource pools |

Parameters

| | |
|---|---|
| ${C}_{n t}^{r}$ | The capacity of resource r(r ∈ Rₜ) in node n(n ∈ Nₜ) of node type t |
| ${π}_{n t}^{p}$ | Binary parameter indicating whether node n of node type t is in pool p(p E P) |
| ${η}_{n t}^{v}$ | Binary parameter indicating whether workload v(v ∈ V) currently uses node n of node type t |
| ${D}_{r t}^{v}$ | The amount of resource r allocated by a certain node of node type t to workload v. |
| θ | Weight factor, θ ∈ [0, 1] |

Decision variables

| | |
|---|---|
| ${x}_{n t}^{v}$ | Binary variable that equals to one if workload v uses node n of node type t after the consolidation; equals to zero, otherwise |
| yᵥₚ | Binary variable that equals to one if workload v uses pool p after the |
| | consolidation; equals to zero, otherwise. |
| zₙₜ | Binary variable that equals to one if node n of node type t is active after the |
| | consolidation; equals to zero, otherwise. |
| N^{Act} | Integer variable denoting the number of active nodes after the consolidation. |
| N^{Mig} | Integer variable denoting the number of migrated elements |

In this embodiment, the constraints are useful for various purposes. Constraint (5) ensures that if a workload uses one node of a certain node type before the consolidation, i.e.,

$${\sum }_{n ∈ {N}_{t}} {η}_{n t}^{v} = 1 ,$$

it also uses one node of this node type after the consolidation, i.e.,

$${\sum }_{n ∈ {N}_{t}} {x}_{n t}^{v} = 1 .$$

Constraint (6) ensures that a workload can only use one resource pool. Constraint (7) ensures that a workload is not assigned to a pool if it does not utilize any of its nodes. Conversely, constraint (8) guarantees that if a workload does utilize nodes from a pool, it is assigned to that specific pool. Constraint (9) ensures that a node is active as long as there are workloads using this node. Constraint (10) ensures that a node is inactive when no workload uses this node. Constraint (11) ensures that the capacity restriction of each node is not violated. Constraint (12) calculates the number of active nodes. Constraint (13) counts the number of migrated elements by summing the number of elements whose new placement differs from their initial placement, i.e.,

$${η}_{n t}^{v} \cdot ( 1 - {x}_{n t}^{v} ) = 1 .$$

Experiments and tests have been performed on the Q-learning based workload consolidation algorithm embodiment (as well as other algorithms, for comparison) to obtain numerical results. Details of these experiments and tests, and their results, are now described.

First, the test conditions of the experiments and tests are as follows.

In this example, five types of nodes are considered, i.e., T={Computing, Memory, A1, A2, A3}, where A1, A2, A3 represent three types of accelerators. A total of 90 nodes (30 computing nodes, 30 memory nodes, 10 A1 nodes, 10 A2 nodes, and 10 A3 nodes) are considered. Each computing node contains 48 (CPU) cores and 192 GB of local memory. Each memory node contains 1536 GB of memory. Each of the A1 nodes, A2 nodes, and A3 nodes contains 60 A1 units, 60 A2 units, and 60 A3 units, respectively.

Three cases regarding the disaggregation scales are considered, by grouping the 90 nodes into 1, 5, and 10 pools respectively. In each of these cases, all nodes of each node type are equally distributed in each pool. For example, in the 5-pool case, each pool contains 6 computing nodes, 6 memory nodes, 2 A1 nodes, 2 A2 nodes, and 2 A3 nodes. A total number of 120 workloads are considered, each requesting a certain amount of cores, local memory, memory, and one of the three accelerators. The resource demand is randomly generated, with U[1, 12] of cores, U[1, 48] GB of local memory, U[32, 384] GB of memory, and U[1, 15] units of A1, A2, or A3; where U[a, b] is a uniformly random integer value that varies from a to b (with a and b included). The probabilities of workloads requiring A1, A2, or A3 are assumed to be equal. The initial placement of these workloads is generated using a random allocation method to ensure all nodes are active with all initial workloads successfully accommodated. In this example Java is used to develop the simulation environment and the commercial solver AMPL/Gurobi is employed to solve the ILP formulations.

In the experiments and tests of this example, the performances of the following solutions (algorithms) are compared:
1. ILP: This solution is obtained by solving the ILP formulation embodiment disclosed above
2. Q-learning based (QL): This solution is provided by the Q-learning based workload consolidation algorithm embodiment disclosed above
3. Simulated Annealing (SA): This solution is obtained based on the SA algorithm, as disclosed in Kirkpatrick et al., “Optimization by simulated annealing” (1983). SA mimics the annealing process in metallurgy, where a material is gradually cooled to reduce defects. In the implementation in this example, the temperature is initialized as T=θ×(total number of resource nodes)+(1-0)×total number of elements. The algorithm starts with the original workload placement as the initial solution. Iteratively, an element is randomly migrated to a different host, and this migration is accepted or rejected based on the probability

$${P}_{a c c e p t} = min ( 1 , {e}^{\frac{- Δ E}{T}} ) ,$$

where ΔE represents the change in objective value. For each value of T, the trial-accept/deny process is repeated 10⁶ times. Then, the temperature is reduced with a cooling rate of 0.999, i.e., T_{new} =0.999T. This cycle is repeated until T drops below the threshold of 10⁻⁶. To ensure the single-pool constraint, when an element is moved to a different pool, the migration of its related elements is forced to the same pool. Among the feasible resource nodes in this pool, the one with the highest P_{accept} is chosen.
4. FF: This solution is obtained by employing the First-Fit (FF) method. It finds the first available pool to host a given workload and then selects the first node within that pool that can accommodate each workload element.
5. FFD: This solution is obtained using the First-Fit Decreasing (FFD) method. It sorts the workload in descending order of their CPU demands and then applies the FF method to allocate each workload.
6. ILP for an SDC: This solution is obtained by extending the ILP formulation embodiment to solve the workload consolidation problem in an SDC. Specifically, constraint (13) is modified by multiplying the value of N^{mig} by 3, since each server in an SDC contains three elements for each workload. To ensure equivalent node numbers and resource capacities as in the CDC cases, in this case, 90 server nodes (each with 16 cores, 64 GB of local memory, and 512 GB of shared memory) are considered. In this example, the server memory is differentiated into local and shared parts for ensuring fair comparisons. In addition, among the 90 servers, 30 are equipped with 20 A1 units each, another 30 have 20 A2 units each, and the remaining 30 are equipped with 20 A3 units each.

Pareto fronts by the ILP formulation are now presented.

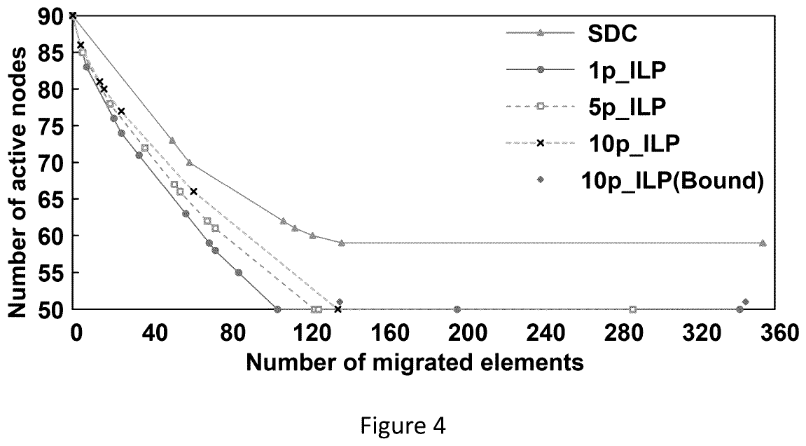

FIG. 4 shows the Pareto fronts obtained by solving the ILP formulation embodiments with varied weights θ in the objective function (1). In FIG. 4, “1p_ILP,” “5p_ILP,” “10p_ILP,” and “SDC” correspond to the results of the 1-pool CDC, 5-pool CDC, 10-pool CDC, and the SDC, respectively.

As shown in FIG. 4, for all four test cases, a reduction of the number of active nodes leads to an increase in the number of migrated elements, which illustrates the trade-off between efficiency improvement and migration cost in workload consolidation. Nevertheless, the ILP Pareto fronts of the three CDC cases are significantly lower than that of the SDC case, which implies resource pooling can effectively enhance resource efficiency by addressing the resource-stranding issue in traditional server-based architecture. In the SDC case, the number of active nodes is reduced by a maximum of 31, resulting in a decrease from 90 to 59 active nodes. In contrast, in all three CDC cases, there is a maximum reduction of 40 active nodes, representing a 29% improvement compared to the SDC case. Furthermore, this improvement is achieved with fewer migrated elements. When the number of active nodes is reduced to the lower bound, the numbers of migrated elements are 105, 124, and 136 in the 1-pool, 5-pool, and 10-pool CDC cases, respectively. In comparison, this value is 138 in the SDC case. These results show that the CDI-based architecture can achieve higher resource efficiency with less migration cost than the server-based architecture. When comparing the three CDC cases, it can be found that the 1-pool CDC performs the best, followed by the 5-pool CDC, and finally, the 10-pool CDC. This trend demonstrates that the larger the disaggregation scale, the more benefits can be obtained by implementing the CDI.

In FIG. 4, there are two results labelled as “10p_ILP (Bound)” for the 10-pool CDC cases with weight factors of 0.95 and 1.0. These results are not included in the Pareto front as they are not optimal. For θ=0.95, after running for 1210989.44 seconds (14.02 days), the ILP solver could not find an optimal solution and instead it only provides a high-quality approximate worst-case feasible solution with an upper bound objective value of 55.3. For this case, the numbers of active nodes and migrated elements are 51 and 137, respectively. The solver also provides a lower bound of 53.95, resulting in a gap of 2.44%. Similarly, for θ=1.0, the obtained numbers of active nodes and elements are 51 and 345, respectively. In this case, the running time required is 1210396.87 seconds (14.01 days), and the gap is 1.96%. These results highlight the high computational complexity of the ILP formulation due to its NP-hardness property. This underscores the necessity of the Q-learning based method in some cases.

Performance of the Q-learning based algorithm embodiment is now presented.

In one test, the total number of epochs, i.e., N^{Epk}, is set as one million. The discount factor γ is empirically set to 0.9, which indicates a preference for future rewards over immediate rewards. However, for ε and α, different settings have been applied and different outcomes are obtained.

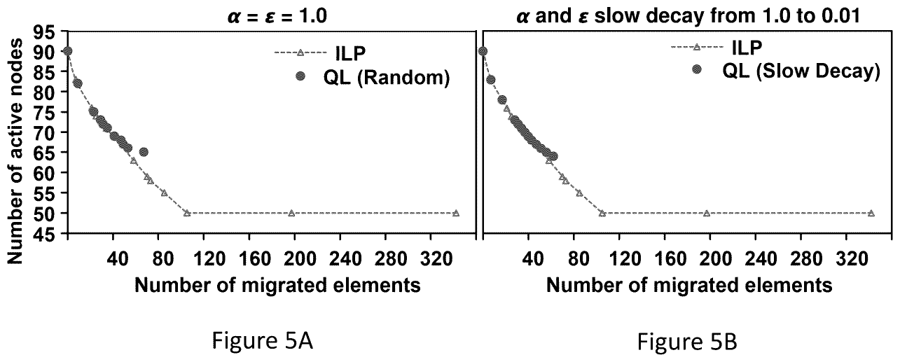

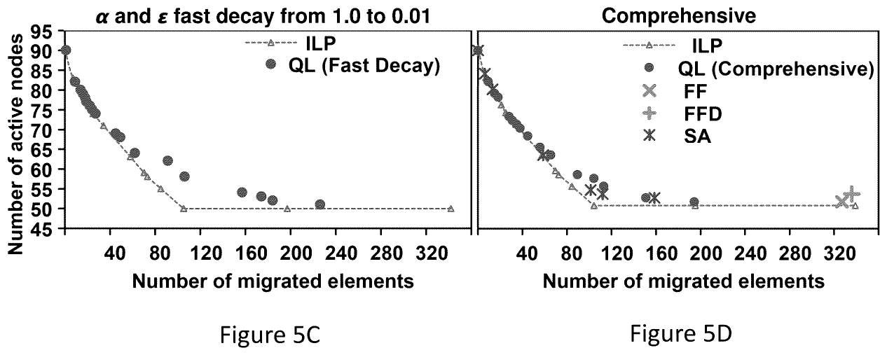

FIGS. 5A to 5D show the results of the 1-pool CDC obtained in four different settings of ε and α.

FIG. 5A shows the results when ε=α=1. Under this setting, the agent always takes random actions (when ε=1) and focuses only on future experience exploration (when α=1). The results depicted in the figure closely align with the ILP Pareto fronts. However, the results concentrate on a region where the number of active nodes remains equal to or above 64. Therefore, this performance is unsatisfactory in this example as it can never reduce the number of active nodes below 64. The reason is that the agent does not exploit the learned knowledge, resulting in lower overall performance. This resembles random attempts without a clear direction, making it challenging to achieve satisfactory performances.

FIG. 5B shows the results when ε and α slowly decay from 1.0 to 0.01. Specifically, their values exponentially decline from 1.0 to 0.01 over (N^{Epk}−500) epochs. The obtained results are similar to those in the random case shown in FIG. 5A. The results indicate that the agent lacks sufficient exploitation, leading to suboptimal outcomes.

FIG. 5C shows the results of the fast-decay case where & and a exponentially decay from 1.0 to 0.01 over 500 epochs. From the perspective of the results region, the performance is better than the previous two cases (FIGS. 5A and 5B) as the range of the number of active nodes is very close to that of the ILP Pareto fronts. This performance improvement is due to a sufficient exploitation of existing knowledge. However, as shown in FIG. 5C, around the region near the inflection point of the ILP Pareto front, i.e., the area near the point (105, 50), the results obtained by the Q-learning based method embodiment are not that close to the ILP Pareto front as the results in other areas. This inflection point represents the most challenging point to reach, indicating the minimum number of elements that must be migrated when reducing the number of active nodes to its lowest possible value.

In one test, fast-decay and slow-decay strategies are combined to enhance performance. Specifically, in this test, learning is divided into slots of 20,000 epochs. In the first slot, fast decay, where ¿ and a decay from 1.0 to 0.01 over 500 epochs, is applied. In subsequent slots, slow decay, where their values restart at 1.0 and decay to 0.01 over 10,000 epochs, is applied.

FIG. 5D shows the obtained results, and it can be seen that the performance is indeed improved. This improvement is because the fast decay in the first slots avoids falling into the suboptimal area while the slow decay in subsequent slots allows the agent more exploration, and this exploration is not without directions but is based on the direction provided by the first slot. FIG. 5D also shows the results of SA. It can be seen that the SA-based solution performs very similarly to the Q-learning based method embodiment, which is due to the similarity between the two solutions in terms of their exploration-exploitation trade-off. Both algorithms aim to balance between exploring new states/actions and exploiting the current best-known solution. Q-learning uses ε-greedy exploration strategy whereas SA explores the search space by occasionally accepting worse solutions based on a temperature parameter. FIG. 5D also shows the results of FF and FFD. These results demonstrate that FF and FFD can effectively reduce the number of active nodes. However, both FF and FFD involve a substantial migration of elements, which suggests that the heuristic algorithms struggle to optimize both objectives simultaneously.

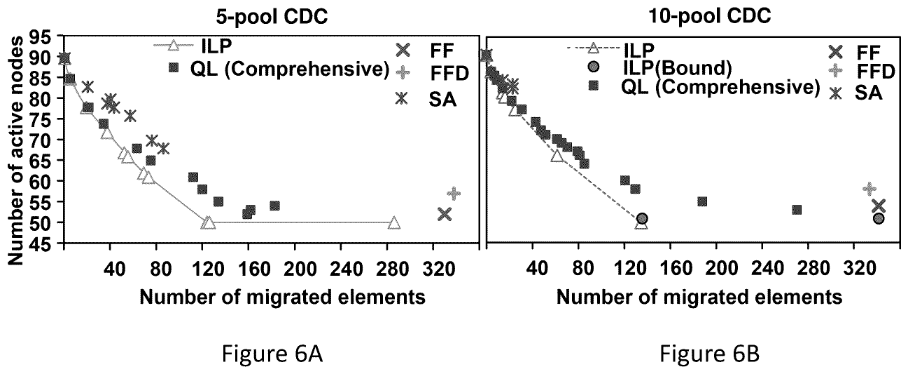

FIGS. 6A and 6B show the results for 5-pool and 10-pool CDC cases. In this example, the settings of α and ε for the Q-learning based method embodiment are the same as those for obtaining the results of FIG. 5D. The results show similar trends to the results for 1-pool CDC. The closer to the initial state, i.e., point (0, 90), the closer the results are to the ILP Pareto front. This trend reflects that the optimization difficulty increases with the reduction in active node number. Additionally, when comparing the results in FIG. 5D and FIGS. 6A-6B, it is found that the performance of the Q-learning based algorithm embodiment shown in the 10-pool CDC is not as good as that in the 1-pool and 5-pool CDCs. This observation aligns with the fact that when θ is set to 0.95 or 1.0, the ILP formulation solver produces suboptimal results after an extensive computational time in the 10-pool CDC. The reason is that in the 10-pool CDC, resource nodes are arranged into numerous isolated pools, increasing the likelihood of encountering infeasible combinations that violate the single-pool constraint (Constraint (6)). Consequently, the probability of the Q-learning agent or the ILP solver converging to the optimal solution in the 10-pool CDC is lower than that in the 1-pool and 5-pool CDCs.

FIGS. 6A and 6B also show that SA considerably underperforms the Q-learning based solution embodiment. Specifically, the number of active nodes in the 5-pool and 10-pool CDCs cannot be significantly reduced by SA, indicating SA's inability to attain high resource efficiency. This contrasts significantly with the performance comparison between SA and the Q-learning based solution embodiment in the 1-pool CDC scenario, where SA performs very similarly to the Q-learning based solution embodiment. This inconsistency in the performance discrepancy between SA and the Q-learning based solution embodiment across different scenarios can be attributed to the fact that the Q-learning based solution embodiment utilizes a dynamic action space (as discussed above). This approach ensures that each element is selected at least once and only once for the migration trial in each epoch. This allows the Q-learning based solution embodiment to explore the action space more comprehensively, especially when resource nodes are divided into multiple pools, as evidenced by the 5 and 10-pool scenarios. In contrast, SA uses a simple greedy method to randomly select an element in every migration trial. This method is less effective when the action space is large, as it is more likely to select the same elements multiple times and miss other potential good solutions.

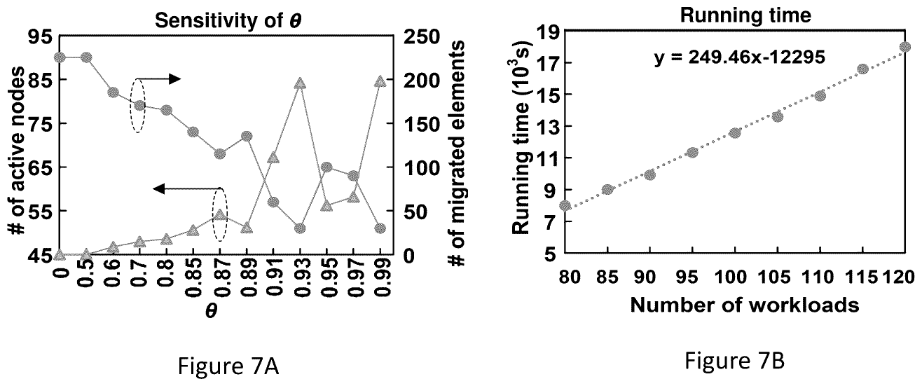

In one test, the sensitivity of the trade-off surface to θ and the running time of the algorithm as the workload number increases in the Q-learning based method embodiment are assessed. FIGS. 7A and 7B illustrate the results.

FIG. 7A shows the numbers of active nodes and migrated elements with varying θ. It can be observed that initially, no node migration occurred, and both the number of active nodes and migrated elements remained unchanged. Also, as θ exceeds 0.5, the number of active nodes gradually decreases while the number of migrated elements increases. This behavior demonstrates the effectiveness of θ in balancing the two objectives. Notably, when θ exceeded 0.87, significant fluctuations and a wide range of variability in the results are observed.

FIG. 7B shows the running time results where the trendline is included. The outcomes reveal a linear increasing trend, which is consistent with the time complexity analysis disclosed above. According to this analysis, the time complexity is linear with respect to the number of elements. Since the average number of elements has a linear relationship with the workload number, the time complexity also exhibits linearity with the workload number.

The above disclosure of the more-specific embodiments has considered the workload consolidation problem in CDCs. The embodiment provides a method that aims to minimize the number of active nodes and the number of migrated workload elements. The embodiment provides a Q-learning based algorithm, which can optimize an objective function to generate an approximate Pareto front. An ILP formulation has been developed to validate the performance of the Q-learning based algorithm. The ILP Pareto fronts in various test cases have highlighted the improved consolidation performance of the CDCs over the SDCs in terms of both energy efficiency savings and migration cost reduction. The numerical results have shown that the Q-learning based algorithm can closely approximate the ILP Pareto front while can overcome its key drawback of high complexity. Moreover, the Q-learning based algorithm includes carefully-designed modifications to the traditional Q-learning method, including the modification associated with the dynamic action space, the Q-learning based algorithm can significantly outperform an SA-based method. Lastly, the Q-learning based algorithm also overcomes the drawback of the heuristic algorithms, FF and FFD, which do not consider migration costs. Accordingly, the Q-learning based algorithm can provide a significant performance improvement over FF and FFD.

It should be noted that while the Q-learning based approach (as in the above the Q-learning based algorithm embodiment) is designed for consolidating workloads in CDCs, it is envisaged that the Q-learning based approach can also be applicable for consolidating workloads in SDCs. For example, for consolidating workloads in SDCs, the approach can be adapted by considering only computing nodes (and ignoring memory nodes and other node types) and the virtual node demand of each request can be reduced to contain only one element (e.g., virtual machine) instead of multiple elements.

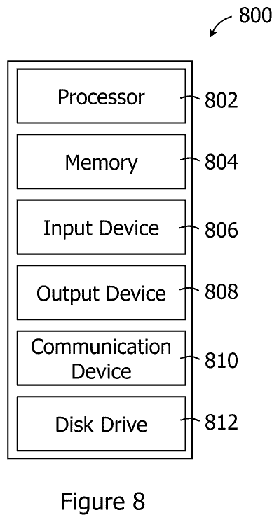

FIG. 8 shows an example information handling system 800 that can be used to perform the method in some embodiments of the invention. For example, the information handling system 800 can be used to perform method 100. For example, the information handling system 800 can be used to perform the method involving ILP formulations, the method involving Q-learning based workload consolidation, the method involving simulated annealing, the method involving first-fit method, the method involving first-fit decreasing method, etc. For example, the information handling system 800 can be used to provide one or more servers in a data center.

The information handling system 800 includes suitable components necessary to receive, store, and execute appropriate computer instructions, commands, and/or codes. In this example, the information handling system 800 includes a processor 802 and a memory 804. The processor 802 may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions, and/or to process signals and/or information and/or data. The memory 804 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data are stored in the memory 804. For example, computer instructions for executing or facilitating executing of the method embodiments of the invention may be stored in the memory 804. The processor 802 and memory 804 may be integrated or separated (and operably connected).

The information handling system 800 may further include one or more input devices 806. Examples of an input device 806 include: keyboard, mouse, stylus, image scanner, microphone, tactile/touch input device (e.g., touch sensitive screen), image/video input device (e.g., camera), etc. The input device 806 may be used to receive a user input (e.g., selection of a Pareto optimal solution).

The information handling system 800 may further include one or more output devices 808. Examples of an output device 808 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The output device 808 may be used to present a representation of the Pareto solutions or Pareto front.

The information handling system 800 may further include one or more disk drives 812 which may include one or more of: solid state drive, hard disk drive, optical drive, flash drive, magnetic tape drive, etc. A suitable operating system may be installed in the information handling system 800, e.g., on the disk drive 812 or in the memory 804. The memory 804 and the disk drive 812 may be operated by the processor 802.

The information handling system 800 may further include a communication device 810 for establishing one or more communication links with one or more other computing devices, such as servers, personal computers, terminals, tablets, phones, watches, IoT devices, or other wireless computing devices. The communication device 810 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, 6G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data.

In one example, the processor 802, the memory 804 (optionally the input device(s) 806, the output device(s) 808, the communication device(s) 810 and the disk drive(s) 812, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network. A person skilled in the art appreciates that the information handling system 800 is merely an example and that in other embodiments the information handling system 800 can have a different configuration (e.g., with additional components, fewer components, alternative components, etc.).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular function, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include any appropriate arrangement of computer or information processing hardware capable of implementing the function described.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive.

1. A computer-implemented method for consolidating workloads in a data center, comprising:
obtaining information associated with workloads in the data center;
optimizing an objective function for workload consolidation based at least in part on the obtained information, the objective function being established for optimizing energy efficiency and workload migration in the data center;
obtaining, based at least in part on optimizing the objective function, a plurality of Pareto optimal solutions, each Pareto optimal solution respectively representing an optimal energy efficiency for a corresponding number of migrations associated with the workloads or an optimal number of migrations associated with the workloads for a corresponding energy efficiency; and
consolidating the workloads in the data center based at least in part on at least one of the plurality of Pareto optimal solutions.

2. The computer-implemented method of claim 1, wherein the objective function is established to optimize the energy efficiency and the workload migration by maximizing the energy efficiency and minimizing the number of migrations associated with the workloads.

3. The computer-implemented method of claim 2,
wherein the data center comprises a plurality of nodes each respectively comprising one or more types of computing resource, the plurality of nodes comprises active nodes;
wherein the workloads are distributed in the active nodes;
wherein the objective function is established to optimize the energy efficiency and the workload migration by minimizing the number of active nodes in the data center and minimizing the number of migrations associated with the workloads.

4. The computer-implemented method of claim 3,
wherein the objective function is representable as:
$$θ \cdot {N}^{A c t} + ( 1 - θ ) \cdot {N}^{M i g}$$
where N^{Act} is the number of active nodes, N^{Mig} is the number of migrations associated with the workloads, and θ∈[0, 1] is a weight factor; and
wherein optimizing the objective function comprises applying different weight factors to the objective function.

5. The computer-implemented method of claim 3,
wherein the number of migrations associated with the workloads is the number of migrations of the workloads; and
wherein consolidating the workloads comprises migrating one or some of the workloads from one or more of the active nodes to another one or more of the active nodes to reduce the number of active nodes.

6. The computer-implemented method of claim 3,
wherein the data center has a server-based architecture, in which each of the plurality of nodes is respectively associated with a server having a plurality of types of computing resources;
wherein the plurality of nodes comprises a plurality of processing nodes each comprising processing resource; and
wherein the active nodes comprise active processing nodes.

7. The computer-implemented method of claim 3, wherein the workloads comprise a plurality of workload elements distributed in the active nodes;
wherein the number of migrations associated with the workloads is the number of migrations of the workload elements; and
wherein consolidating the workloads comprises migrating one or some of the workload elements from one or more of the active nodes to another one or more of the active nodes to reduce the number of active nodes.

8. The computer-implemented method of claim 7, wherein the data center has a composable architecture, in which each of the plurality of nodes respectively comprises one or more types of computing resource, and the plurality of nodes are arranged in a plurality of resource pools, the plurality of resource pools are isolated from each other.

9. The computer-implemented method of claim 8,
wherein the plurality of nodes comprises a plurality of processing nodes each comprising processing resource and a plurality of memory nodes each comprising memory resource;
wherein the active nodes comprise active processing nodes and active memory nodes; and
wherein consolidating the workloads comprises:
migrating one or some of the workload elements from one or more of the active processing nodes to another one or more of the active nodes to reduce the number of active processing nodes; and/or
migrating one or some of the workload elements from one or more of the active memory nodes to another one or more of the active nodes to reduce the number of active memory nodes.

10. The computer-implemented method of claim 4, wherein the optimizing of the objective function is performed based least in part on a reinforcement learning method.

11. The computer-implemented method of claim 10, wherein the reinforcement learning method is a Q-learning based reinforcement learning method.

12. The computer-implemented method of claim 11, wherein the Q-learning based reinforcement learning method comprises:
receiving an input comprising value for the weight factor, initial placement of workload elements, start state, action set, and epoch number; and
performing a learning operation based at least in part on the received input to determine an optimal placement of the workload elements.

13. The computer-implemented method of claim 12,
wherein the learning operation is performed for a plurality of epochs corresponding to the epoch number; and
wherein the learning operation comprises, in each epoch:
obtaining a list including a plurality of possible actions;
performing action selection operation to select action from the plurality of possible actions;
performing an action application operation to apply the selected action to facilitate transition from a start state to a next state;
performing a reward collection operation to obtain a reward in response to the transition;
performing a Q-value update operation; and
performing an optimal placement update operation.

14. The computer-implemented method of claim 13,
wherein the reward is representable as
$$- A \times ( θ \cdot Δ {N}^{A c t} + ( 1 - θ ) \cdot Δ {N}^{M i g} )$$
where A is a constant, AN Act is change in the number of active nodes after the corresponding action is applied, and AN^{Mig} is change in the number of migrations of the workload elements after the corresponding action is applied.

15. The computer-implemented method of claim 13,
wherein for each epoch, the start state corresponds to placement of workload elements that yields a minimum value of the objective function obtained so far in the learning operation.

16. The computer-implemented method of claim 13,
wherein performing the action selection operation comprises determining feasibility of an action with respect to the workload element.

17. The computer-implemented method of claim 13,
wherein if the action application operation migrates a workload element from a current resource pool to another resource pool, then the learning operation further comprises, in each epoch:
updating the list in response to performing the action application operation, wherein updating the list comprises changing the list to include only actions arranged to migrate any workload elements belong to the same workload as the workload element to the another resource pool.

18. The computer-implemented method of claim 13,
wherein if the action application operation does not migrate a workload element from a current resource pool to another resource pool, then the learning operation further comprises, in each epoch:
updating the list in response to performing the action application operation, wherein updating the list comprises:
removing, from the list, all actions associated with a workload element to which action has been applied; and
removing, from the list, all actions associated with migrating workload elements belonging to the same workload as the workload element to one or more resource pools different from that of the workload element.

19. The computer-implemented method of claim 1,
wherein the computer-implemented method further comprises selecting one of the plurality of Pareto optimal solutions; and
wherein the consolidating of the workloads is based at least in part on the obtained information and the selected Pareto optimal solution.

20. A system comprising:
one or more processors; and
memory storing a computer program configured to be executed by the one or more processors, the computer program comprising instructions for performing or facilitating performing of the computer-implemented method of claim 1.
